(19) United States
(12) Patent Application Publication
(10) Pub. No.: US 2009/0228137 A1
(43) Pub. Date: Sep. 10, 2009

(54) METHOD FOR TESTING THE FIT OR FOR TESTING THE IMBALANCE OF A TOOL

(75) Inventors: Moshe Israel Meidar, New York, NY (US); Wolfgang Horn, Goeppingen (DE); Thomas Bayha, Markgroeningen (DE); Ralph Davis, Eislingen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Ex-Cell-O GmbH

(21) Appl. No.: 12/403,662

(22) Filed: Mar. 13, 2009

Related U.S. Application Data
(63) Continuation of application No. PCT/EP2008/060868, filed on Aug. 20, 2008.

(30) Foreign Application Priority Data
Sep. 10, 2007 (DE) 10 2007 044 458.5

(51) Int. Cl. G06F 19/00; B23Q 17/00

(52) U.S. Cl. 700/175; 409/131; 29/407.05

(57) ABSTRACT

A method is provided for testing the fit or for testing the imbalance of a tool exchangeably accommodated in a tool spindle which is mounted for rotation about a central longitudinal axis and is rotationally driven by a spindle drive motor, including: inserting the tool on the tool spindle; making the tool spindle rotate with a specific rotational frequency f_{def} about the central longitudinal axis by means of the spindle drive motor; analyzing an actual value of a controlled drive current of the spindle drive motor with respect to a frequency component with the rotational frequency f_{def}; and determining whether the frequency component with the rotational frequency f_{def} lies within a threshold value range.

### CROSS REFERENCE TO RELATED APPLICATIONS

This application is a continuation of PCT Application No. PCT/EP2008/060868, filed Aug. 20, 2008, and also claims the benefit of German Application No. 10 2007 044 458.5, filed Sep. 10, 2007, both of which are incorporated herein by reference in their entirety and for all purposes.

### BACKGROUND OF THE INVENTION

The invention relates to a method for testing the fit or for testing the imbalance of a tool exchangeably accommodated in a tool spindle which is mounted for rotation about a central longitudinal axis and is rotationally driven by a spindle drive motor.

Tool spindles are used in a machine tool. In order to achieve high machining accuracy, an inserted tool should run as true as possible. Deviations from running true may result from a non-aligning fit of the tool in the tool spindle due to contaminant or from various kinds of tool imbalances. Such irregularities are to be detected and rectified.

It is known from EP 0 881 032 A2 (corresponding to U.S. Pat. No. 6,059,702 A) to clean abutment surfaces with compressed air or with the coolant of the machine tool when inserting a tool. Moreover, it is possible to check the correct, i.e., aligning, fit of the tool, following insertion, by introducing compressed air and detecting the resulting decrease in pressure. However, a separate device for measuring the pressure is required for this.

The checking also takes a relatively long time as the drop in pressure to be analyzed usually only takes place slowly.

It is known from EP 1 745 884 A1 to test the aligning fit of a tool in a tool spindle using a light beam.

A device for detecting abnormal operation of a rotary tool having a plurality of edges is known from JP 61050758 A.

### SUMMARY OF THE INVENTION

In accordance with the present invention, a simple and quick method for testing the fit or for testing the imbalance is provided.

In accordance with an embodiment of the invention, the tool is inserted on the tool spindle, the tool spindle is made to rotate with a specific rotational frequency f_{def} about the central longitudinal axis by means of the spindle drive motor, an actual value of a controlled drive current of the spindle drive motor is analyzed with respect to a frequency component with the rotational frequency f_{def}, and it is determined whether the frequency component with the rotational frequency f_{def} lies within a threshold value range.

In the method according to the invention, the current ripple of the drive current of the spindle drive motor is analyzed. A check is carried out as to the extent to which the component with the specific rotational frequency (namely the frequency component with the specific rotational frequency of the tool spindle) is contained therein. This component is directly attributable to a non-aligning fit or a tool imbalance. A non-aligning fit or a tool imbalance is then recognizable from the analysis.

The method according to the invention can be carried out without any special additional hardware components. Furthermore, a detection of the actual value of the drive current can be used with the necessary evaluation algorithms. The additional apparatus expenditure is thereby minimized.

All of the work steps of the method according to the invention can be carried out quickly. An evaluation of the actual value of the drive current is possible within an extremely short time. In particular, there is no need to wait until measuring is possible again after dead times.

It is expedient for the tool spindle to be arranged on a machine tool. Testing the fit or testing the imbalance of a tool on a machine tool can thereby be carried out in a simple way.

In particular, a spindle controller controls the drive current of the spindle drive motor in order to maintain the rotational frequency. The method according to the invention can then be carried out in a simple way with minimized hardware expenditure.

In particular, the actual value of the drive current is detected at the spindle controller. The controlling of the current can thereby be analyzed in its frequency dependence and, in particular, with respect to its frequency component at the rotational frequency f_{def} in a simple way.

It may be provided that the spindle controller is arranged on the tool spindle and/or the spindle controller is arranged in a control device. The control device itself may be arranged on the tool spindle or it may be arranged remote from the tool spindle, for example, within a machine cladding of a machine tool.

It is expedient for comparative values for the component of the actual value of the drive current at the specific rotational frequency to be stored in a database. Prevailing irregularities can thereby be specified on the basis of comparative values in a simple way. In particular, known types of irregularity are stored in a database. A reference measurement may be carried out for a tool that has not yet been inserted so as to generate corresponding comparative values for the database.

In particular, when a tool is used for the first time, the frequency component of the actual value of the drive current with the rotational frequency f_{def} is detected at one or more rotational frequencies f_{def} and stored in the database. Comparative values are thereby generated for the corresponding tool.

It may be provided that the actual value is detected several times. When generating comparative values when a tool is being used for the first time, a multiple actual value detection serves for data verification. When testing for fit or testing for imbalance of a tool that is to be inserted, a multiple actual value detection serves to correctly position the tool. For example, a corresponding analysis is carried out, and if the result is negative (the values lie outside the threshold value range), the tool is exchanged or reinserted. Another actual value detection is then carried out in order to check whether the tool is fitted correctly or there is now only an imbalance that is tolerable.

It is expedient for the tool to be inserted manually or by a mechanical tool changing device. In particular, a tool for workpiece machining is inserted mechanically. When determining comparative values for a tool that is to be newly inserted, the tool can be inserted manually or mechanically.

If the frequency component of the actual value of the drive current with the rotational frequency f_{def} lies outside the threshold value range, it is expedient for the tool to be exchanged and/or reinserted at least once. If an incorrect fit or an intolerable imbalance is recognized, action can then be taken to rectify the fault. Following exchange or reinsertion, another check is carried out by detecting the actual value, in order to test for correct fit or an imbalance.

It may be provided that a control device, in particular, of a machine tool emits a control signal if the frequency component of the actual value of the drive current with the rotational frequency f_{def} is not below the threshold value range and, in particular, is not below the threshold value range even after the tool has been exchanged several times and/or has been reinserted several times. For example, the control signal is a warning signal.

The following description of preferred embodiments serves in conjunction with the drawings to explain the invention in greater detail.

### BRIEF DESCRIPTION OF THE DRAWINGS

In order to assist the understanding of certain embodiments of the invention, reference will now be made to the appended drawings, which are not necessarily drawn to scale, and wherein:

FIG. 1 shows a front view of an embodiment of a machine tool with a three-dimensionally positionable and rotationally drivable tool spindle for accommodating a tool;

FIG. 2 shows a partial cross section of the tool spindle according to FIG. 1 with an aligning fit of the installed tool;

FIG. 3 shows a partial cross section of the tool spindle according to FIG. 1 with a non-aligning fit of the installed tool;

FIG. 4 shows a diagrammatic comparison of an aligning and a non-aligning fit, due to contaminant, of the non-rotating tool;

FIG. 5 shows a diagrammatic comparison of a tool rotation with an aligning and a non-aligning fit;

FIG. 6 shows a diagrammatic representation of an evaluation method in block diagram representation; and

FIG. 7 shows a schematic representation of a filtered signal of the actual value of the current relating to an unbalanced tool.

### DETAILED DESCRIPTION OF THE INVENTION

The present invention now will be described more fully hereinafter. However, this invention may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural referents unless the context clearly dictates otherwise.

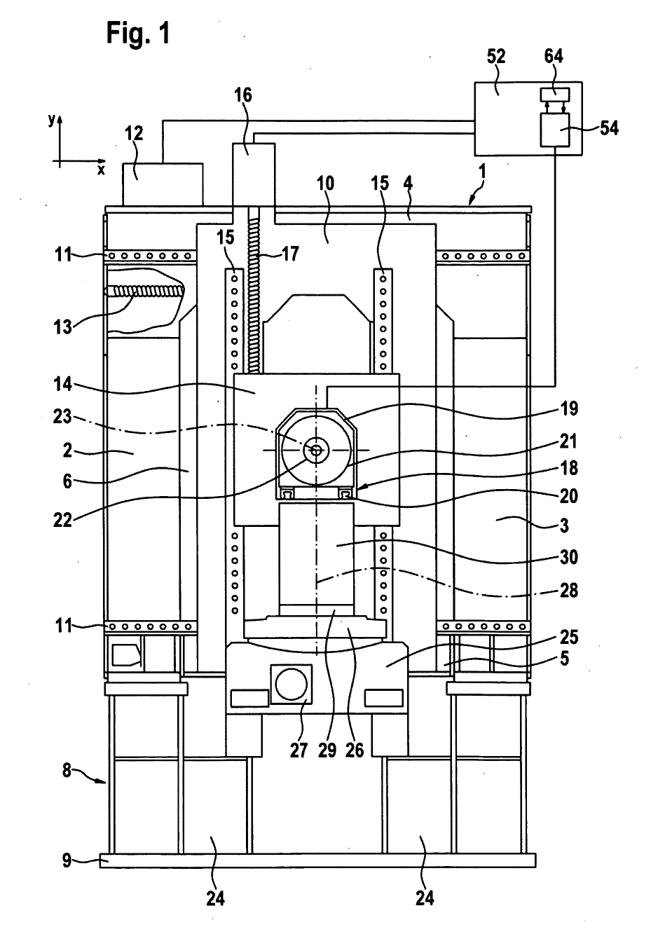

An embodiment of a machine tool shown in FIG. 1 comprises a stand 1 which is formed by a frame and, seen in a horizontal z-direction, is rectangular, more particularly, approximately square. The stand 1 is formed by vertical side supports 2, 3 extending in a y-direction and by a horizontal upper cross beam 4 and a horizontal lower cross bream 5 which extend in an x-direction and join these side supports 2, 3. The y-direction extends perpendicularly to the x-direction and is a vertical direction. The side supports 2, 3 and the cross beams 4, 5 are formed by hollow profiles and enclose an inside space 6 which, seen in a z-direction, is open at both ends, in particular, towards a work space 7. The z-direction extends transversely to the x-direction and to the y-direction. The stand 1 is supported by an underframe 8 on a foundation or a foundation plate 9.

An x-slide 10 which is also constructed in the manner of a frame is arranged so as to be displaceable in the x-direction on the end face of the stand 1 that faces the work space 7. For this purpose, an x-guide rail 11, on which the x-slide 10 is guided, is arranged on each of the cross breams 4, 5. The x-slide 10 is driven by an x-motor 12 via an x-ball bearing spindle 13 extending in the x-direction and mounted in the side supports 2, 3 of the stand 1 or by a linear motor.

A y-slide 14 displaceable in the y-direction, i.e. vertically, is displaceably guided on the end face of the x-slide 10 that faces the work space 7. For this purpose, a y-guide rail 15, on which the y-slide 14 is displaceably guided, is arranged at each of the side regions of the frame-like x-slide 10. The y-slide 14 is driven by a y-motor 16 mounted on the x-slide 10 via a y-ball bearing spindle 17 or by a linear motor.

Located on the y-slide 14 is a tool spindle unit constructed as z-slide 18. This unit comprises a housing-like sleeve 19 which is displaceably guided on z-guide rails 20 mounted in the y-slide 14. The displacement in the z-direction takes place by means of a motor (not shown in the drawings). Arranged in a rotationally fixed manner in the sleeve 19 and immovably in the z-direction is a tool housing 21 of substantially circular cross section, in which, in turn, the actual tool spindle 22 is mounted so as to be rotationally drivable about a central longitudinal axis 23 extending in the z-direction.

Mounted in the work space 7 in front of the stand 1 on the foundation plate 9 is a workpiece carrier bed 24 on which is supported a workpiece carrier 25 constructed in the manner of a bridge. Arranged on the workpiece carrier 25 is a B-rotary table 26 which is drivable for rotation about a vertical B-axis of rotation 28, i.e., running parallel to the y-direction, by a B-rotary motor 27 mounted on the workpiece carrier 25. Mounted on the B-rotary table 26 is a workpiece carrier 29 which is able to accommodate a workpiece 30 that is to be machined.

To the extent to which the machine tool has so far been described, it is, in principle, known and in common use (cf. for example, EP 0 617 244 B1).

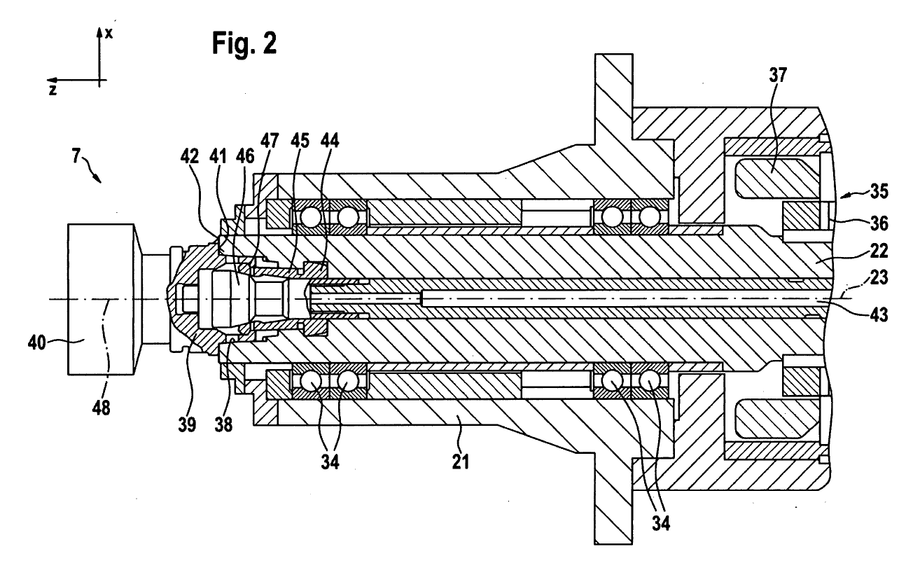

The tool spindle 22 is constructed as a hollow shaft which is rotatably mounted by means of roller bearings 34 in the tool spindle housing 21 (FIG. 2). It is driven by a spindle drive motor 35. The right-hand side of FIG. 2 shows a portion of the spindle drive motor 35, namely the rotor stacks 26 rotationally fixedly connected to the tool spindle 22, and the stator winding heads 37 rotationally fixedly arranged in the tool spindle housing 21.

At its free end facing the work space 7, the tool spindle 22 is provided with a receptacle 38 tapering conically from the outside inwards, into which is inserted a hollow shaft cone 39 of a tool 40 to be accommodated therein. The tool also has an abutment surface 41 which extends radially in relation to the central longitudinal axis 23 and rests against an end face 42 of the tool spindle 22 that extends radially in relation to the axis 23 when the tool 40 is aligned in the tool spindle 22.

Arranged in the tool spindle 22 constructed as a hollow shaft is a tension rod 43 by means of which a collet chuck 44 is actuated, which engages in the hollow shaft cone 39. The collet chuck 44 comprises individual clamping elements 45 which, when the tension rod 43 moves into the tool spindle 22, are pushed outwards by a spreading cone 46 and engage behind corresponding projections 47 in the hollow shaft cone 39, whereby the tool 40 is clamped to the tool spindle 22. Such a configuration of a tool spindle 22 including an actuating unit for the tension rod 43 is known and quite common in practice.

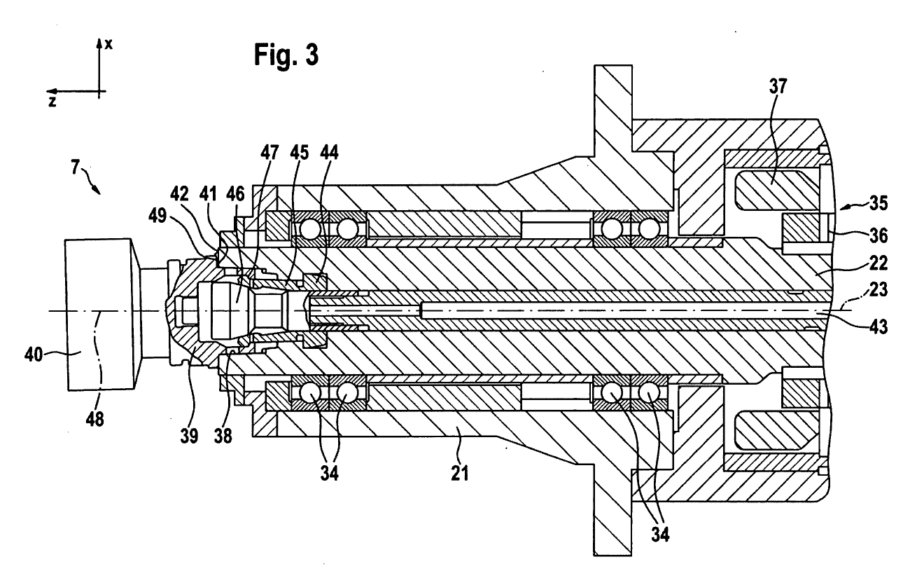

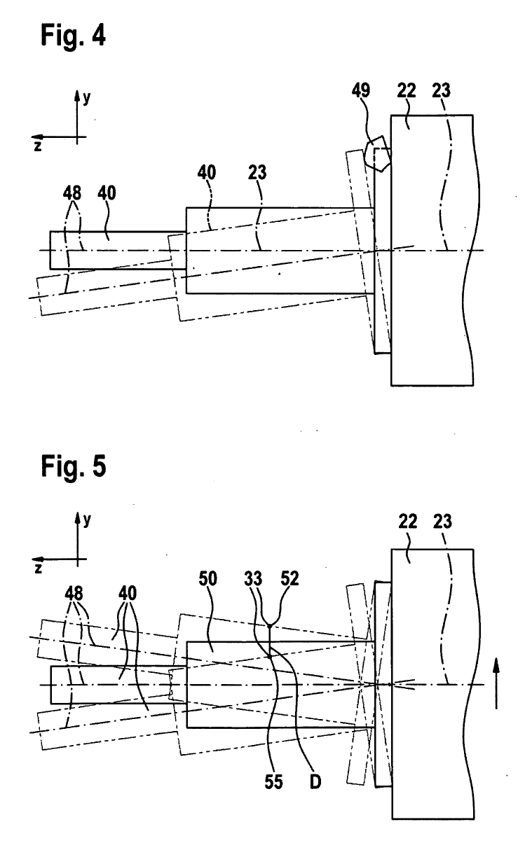

The tool 40 is correctly installed in the tool spindle 22, namely such that the central longitudinal axis 48 of the tool 40 is in coaxial alignment with the central longitudinal axis 23 of the tool spindle 22 (FIG. 2). However, it may also be that the axis 48 is not in alignment with the axis 23. This is the case, for example, when a contaminant 49, for example, in the form of a metal chip or the like, is located between the abutment surface 41 and the end face 42. In such a case, the tool 40 executes a wobbling movement relative to the tool spindle 22 during rotational drive of the tool spindle 42. This is shown in FIG. 3 for the configuration of the tool spindle 22 according to FIG. 2. FIG. 4 shows in dash-dot lines such a non-aligning installation of the tool 40 compared to the aligning position shown in solid lines. FIG. 5 shows in dash-dot lines the untrue rotation of the tool 40 compared to the aligning tool 40 shown in solid lines. Apart from the contaminant 49 an imbalance in the tool 40 may also give rise to such a wobbling movement. Both causes are summarized in the following by the term irregularity.

In the following a method is described, by means of which an untrue rotation of the tool 40 is detected and evaluated, whereby it is checked whether the tool 40 is aligned in the tool spindle 22 and/or whether it has an imbalance which is not shown in more detail in the Figures.

The tool machine comprises a control device 52 which controls the movement and positioning of the tool spindle 22 in the x-direction and y-direction and possibly in the z-direction and the movement and positioning of the workpiece 30 relative to the stand 1. The control device 52 may also comprise an evaluating device. Furthermore, a spindle controller 54 is provided, which controls a drive current of the spindle drive motor 35, in order to rotate the tool spindle about the central longitudinal axis 23 with a specific rotational frequency f_{def}.

The spindle controller 54 may be integrated into the control device 52 or, for example, arranged on the tool spindle 22.

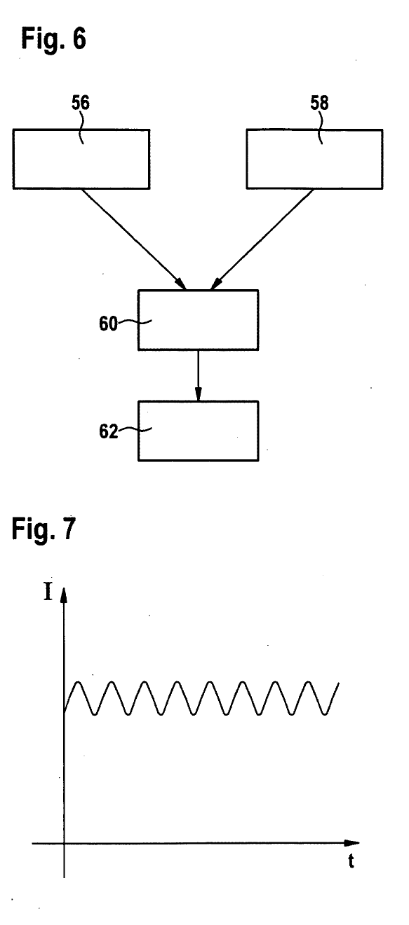

An untrue rotation of the tool 40 on the tool spindle 42 is recognized as follows in accordance with the invention. After a tool change, the tool spindle 22 with the tool 40 inserted therein is set in rotation. The newly inserted tool 40 may be inserted manually or preferably by an automatic tool changing device. After the desired rotational frequency f_{def} (i.e., the set rotational frequency) is reached and prior to engagement of the tool 40 on the workpiece 30, the actual value of the drive current of the spindle drive motor 35 is evaluated. The current is detected. This is indicated diagrammatically by the block with reference numeral 56 in FIG. 6. Furthermore, the associated actual rotational frequency f_{def} is detected. This is indicated by reference numeral 58 in FIG. 6.

A frequency analysis is then carried out on the associated current signal which is plotted against time in FIG. 7. For example, a frequency spectrum is determined using fast Fourier transformation (FFT). This is indicated by reference numeral 60 in FIG. 6. This is followed by an evaluation, for example, in the control device 52. The evaluation is indicated by reference numeral 62 in FIG. 6.

When carrying out the evaluation while the tool spindle 22 is rotated at the specific rotational frequency f_{def}, the actual value of the drive current of the spindle drive motor 35 is analyzed with respect to its frequency component with the rotational frequency f_{def}. This frequency component is a direct measure of an untrue running and, in particular, an imbalance.

The actual value of the drive current may contain components with other frequencies. In particular, it contains components with a multiple of the rotational frequency f_{def}, which are due to the spindle drive motor comprising a discrete number of pairs of poles.

The frequency component of the drive current, which is controlled by the spindle controller 54, with the specific rotational frequency, is determined and compared with reference values at the control device 52.

The reference values are stored in a database 64. A check is carried out as to whether the deviation of the actual value of the drive current with the component with the specific rotational frequency lies within a threshold value range or not. If the deviation lies within the threshold value range, then the tool change is classified as successful and machining of the workpiece can take place.

If a deviation outside the threshold value range is determined, the tool is then exchanged or the tool 40 is inserted again. This step or these steps may possibly be repeated several times.

If it is ascertained that the threshold value range is exceeded and, for example, even after reinserting the tool 40 once or several times, the threshold value range is still exceeded, the control device 52 then emits a control signal which initiates corresponding actions. For example, the control signal is a warning signal which shuts down the machine tool. The warning signal may, for example, also be to the effect that insertion of another tool is requested.

By virtue of the solution according to the invention, the current ripple (FIG. 7) at the actual value of the drive current of the spindle drive motor is analyzed with respect to a component with the specific rotational frequency. An aligning or non-aligning fit of the tool 40 or a tolerable or intolerable tool imbalance is concluded from the analysis.

As a rule, no additional hardware components are required for the method according to the invention. The means provided in any case for moving and positioning the tool spindle 22 may be used. Furthermore, the actual value of the drive current of the spindle drive motor 35 can be detected in a simple way.

The additional apparatus expenditure for performing the method according to the invention for testing for fit and testing for imbalance is, therefore, minimized.

Furthermore, the work steps for performing the method according to the invention can be carried out quickly. An evaluation of the actual value of the drive current is possible within a very short time. There is essentially no dead time or the like during which measuring is not possible.

To determine the reference values stored in the database 64, a tool 40 is inserted when used for the first time, the tool spindle 22 is made to rotate about the central longitudinal axis 23 and in a similar way to that described hereinabove, the component of the actual value of the drive current with the specific rotational frequency is detected and stored in the database 64. These steps may possibly be carried out several times (at least twice) for data verification.

The tool is then exchanged. Such reference measurements may be carried out for different tools 40.

Many modifications and other embodiments of the inventions set forth herein will come to mind to one skilled in the art to which these inventions pertain having the benefit of the teachings presented in the foregoing description. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. Method for testing the fit or for testing the imbalance of a tool exchangeably accommodated in a tool spindle which is mounted for rotation about a central longitudinal axis and is rotationally driven by a spindle drive motor, comprising:
inserting the tool on the tool spindle;
making the tool spindle rotate with a specific rotational frequency f_{def} about the central longitudinal axis by means of the spindle drive motor;
analyzing an actual value of a controlled drive current of the spindle drive motor with respect to a frequency component with the rotational frequency f_{def}; and
determining whether the frequency component with the rotational frequency f_{def} lies within a threshold value range.

2. The method in accordance with claim 1, wherein the tool spindle is arranged on a machine tool.

3. The method in accordance with claim 1, wherein a spindle controller controls the drive current of the spindle drive motor in order to maintain the rotational frequency f_{def}.

4. The method in accordance with claim 3, wherein the actual value of the drive current is detected at the spindle controller.

5. The method in accordance with claim 3, wherein the spindle controller is arranged on the tool spindle.

6. The method in accordance with claim 3, wherein the spindle controller is arranged in a control device.

7. The method in accordance with claim 1, wherein comparative values for the frequency component of the actual value of the drive current with the rotational frequency f_{def} are stored in a database.

8. The method in accordance with claim 7, wherein the frequency component of the actual value of the drive current at one or more rotational frequencies is detected and stored in the database when a tool is used for the first time.

9. The method in accordance with claim 1, wherein the actual value is detected several times.

10. The method in accordance with claim 1, wherein a tool is inserted manually or by a mechanical tool changing device.

11. The method in accordance with claim 1, wherein if the frequency component of the actual value of the drive current with the rotational frequency f_{def} lies outside the threshold value range, at least one of the steps (i) the tool is exchanged; (ii) the tool is reinserted at least once; is performed.

12. The method in accordance with claim 11, wherein a control device emits a control signal if the frequency component of the actual value of the drive current with the rotational frequency f_{def} is not below the threshold value range once or several times.
